(19) United States
(12) Patent Application Publication
(10) Pub. No.: US 2007/0157891 A1
(43) Pub. Date: Jul. 12, 2007

(54) Dog-seat

(76) Inventor: Alon Wayn, Gan-Yavne (IL)

Correspondence Address: ALON WAYN, 11/4 HAMALKOSH ST., P.O. BOX 8230, GAN YAVNE, 70800, IL

(21) Appl. No.: 11/328,213

(22) Filed: Jan. 10, 2006

(51) Int. Cl. B60R 22/00

(52) U.S. Cl. 119/771

(57) ABSTRACT

A dog-seat for restraining a dog within a vehicle; the dog seat comprising a base, a head support, an attaching means and a restraining means; the base member configured to fit onto a seat of the vehicle; the attaching means configured to engage a seatbelt as provided with the seat, the restraining means configured to restrain a dog upon the base without unduly constraining the dog.

### FIELD OF THE INVENTION

The present invention is directed to providing a dog-seat for restraining a dog, allowing it to be carried safely in a vehicle.

### BACKGROUND OF THE INVENTION

Although at one time most people rarely traveled beyond the next village, in the modern world, many people regularly commute, and automobiles and the like, have become the most common means of transportation over short distances of up to 500 km or so.

Unlike cats that can be left to fend for themselves, pet dogs are sociable creatures that many owners take with them on their travels. Although some dogs are well behaved, and will sit still on the floor of a car or other vehicle, other dogs are less well behaved. On long journeys particularly, a pet dog may get restless, and wish to move about the vehicle. An unrestrained dog may disturb other passengers, and, more worryingly, may distract the driver, and a lively unrestrained dog, can, in extreme circumstances even cause the driver to lose control of the vehicle, and may cause accidents. Consequently, there is a need for a dog-seat for restraining dogs traveling in vehicles, and the present invention is directed to providing such a dog-seat.

### SUMMARY OF THE INVENTION

It is an aim of the present invention to provide a dog-seat to restrain a dog whilst travelling in a vehicle.

In a first aspect, the present invention is directed to providing a dog-seat for restraining a dog within a vehicle, comprising a base, a head support, a attaching means and a restraining means: said base member configured to fit onto a seat of the vehicle;

said attaching means configured to engage a seatbelt as provided with said seat;

said restraining means configured to restrain a dog upon said base without unduly constraining said dog.

Preferably a dog upon the base is restrained in a manner that dog faces the direction that a human passenger sitting on said seat would face.

Optionally, the base and head support being fabricated from a polymeric material, such as expanded polystyrene, for example.

Optionally, the base and head support are covered with a fabric.

Optionally, the base and head support are fabricated as a single unit.

Alternatively, the base and head support are fabricated as separate units, coupled together by a coupling means, which may be pivotally connected to the base such that the head support can be rocked backwards and forwards with respect to the base.

Optionally, the coupling means is telescopically extendible to comfortably accommodate dogs of different sizes.

Optionally, the coupling means includes a locking means for locking the coupling means at a desired extension.

In some embodiments, the dog-seat further comprises a body support that allows the dog to rest its front paws on long journeys, by providing an alternative means of supporting its weight, which may be triangular.

In some embodiments, the restraining means comprises a harness attached to the dog and a strap for attaching the harness to the dog-seat.

Alternatively, the restraining means may comprises a plurality of straps that restrains the dog, evenly across its back; the straps being attachable to the dog-seat by a quick release clasp.

In preferred embodiments, the dog-seat further comprises a carrying handle.

In preferred embodiments, the dog-seat further comprises a tensioning means for tensioning the seatbelt.

Optionally, the tensioning means comprises a base plate on which is provided a pair of sprung rollers equipped with opposing toothed surfaces and mounted eccentrically on axes; said base plate for attaching said tensioning means to the dog-seat, and said tensioning means for allowing the seatbelt to be tensioned, so dog-seat rests on seat, tight up against back of seat.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a side elevation view of a first embodiment of the dog-seat of the present invention attached to a car seat, and showing a dog restrained therein.

FIG. 2 is an isometric projection of the embodiment of FIG. 1 without the dog and car seat shown.

FIG. 3 is a side elevation view of a dog-seat in accordance with a second embodiment of the present invention attached to a car seat, and showing a dog restrained therein.

FIG. 4 is a side elevation view of a dog-seat in accordance with a third embodiment of the present invention attached to a car seat, featuring a quick release mechanism.

FIG. 5 is an isometric projection of the base of the dog-seat shown in FIG. 4.

FIG. 6 is a side view of a seatbelt and elliptical locking device, allowing the belt to be drawn out, but preventing it from retracting.

FIG. 7 is an isometric projection of the seatbelt-locking device of FIG. 6.

FIG. 8 is an isometric projection of a dog-seat in accordance with fourth embodiment of the present invention that allows the fore legs of a dog restrained thereon, greater freedom.

FIG. 9 is a cut-away view of a dog-seat in accordance with yet another embodiment of the present invention having a base part resembling a dog basket.

Identical components appearing in more than one Figure are annotated with the same number. Components having a similar function but different structural details are labeled with different, but related numbering in the various Figures.

### DETAILED DESCRIPTION OF THE EMBODIMENTS

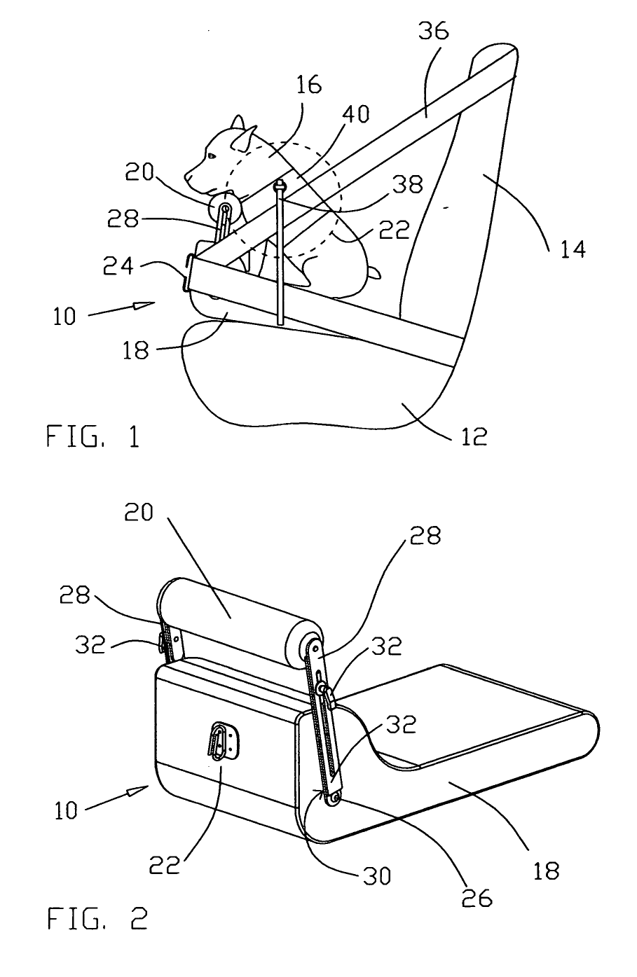

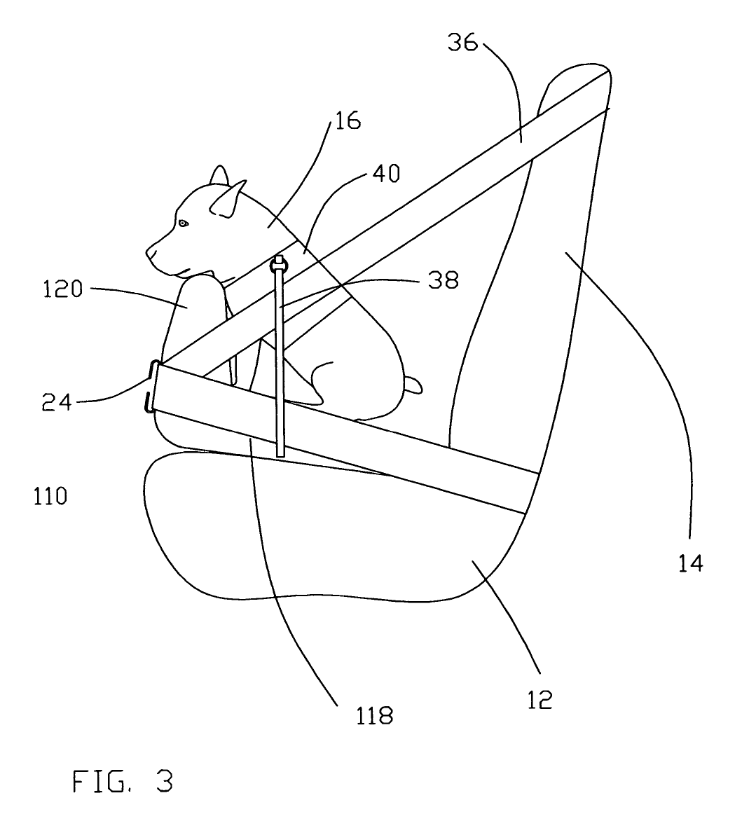

Referring now to FIG. 1, which shows, in side elevation view, a first embodiment of the present invention, being a dog-seat 10, attached to a car seat 12, against the back 14 of the car seat 12 and showing a dog 16 restrained therein. And with further reference to FIG. 2, showing the dog-seat 10 of FIG. 1 in isometric projection, without dog 16 and car seat 12.

The dog-seat 10, in this, and other embodiments consists of four main functional parts, namely: base 18, a head support 20, a restraining means 22 for restraining the dog therein, and an attaching means 22.

The base 18 rests on the car seat 12, and allows a dog 16 to assume a comfortable position thereon, as illustrated herein, a sitting position. The dog 16 is restrained thereon in such a manner that the dog 16 faces the same direction that a human passenger sitting on the car seat 12 would assume, allowing the dog 16 a similar field of view. The head support 20 supports and restrains the head of the dog. As shown in FIG. 2, in this first embodiment, the head support 20 is attached to the base 18 by a pivoting join 26, allowing the head support 20 to be rocked backwards and forwards by the dog 16 sat thereupon, thereby giving the dog 16 a degree of freedom, and thus not unduly constraining him, whilst nevertheless, keeping him restrained. Head support 20 is attached to base 18 by a pair of connectors 28, which preferably can be extended and retracted allowing the distance separating head support 20 and base 18 to be varied. As shown, each connector 28 is constructed from a first piece 30 attached to the base 12 by the pivotal joint 26, and a second piece 32 attached to first piece 30 by a locking nut 34 or similar, such that second piece 32 can slide with respect to first piece 30 enabling connector 28 to be extended in a telescopic manner, thereby enabling the head support 20-base 18 separation to be tailored to the size of the specific pet and enabling the dog seat 10 to be adjusted to different animals. The locking nut 34 enables the desired separation of head support 20 from base 18, once obtained to be fixed. This feature is of value when the same animal is carried on same dog-seat 10 on a regular basis.

The dog-seat 10 is attached to the seat 12 of the vehicle using the seatbelt 36 that is usually provided for human passengers as standard on both front and back seats of cars and other vehicles, and the dog-seat 10 is also provided with an attaching means 22 for engaging the seatbelt 36. The attaching means 22 shown in this embodiment is a clip, but any type of buckle, loop or similar may be used. The dog 16 itself, is fastened within the dog-seat 10 by a strap 38 that is connected to the dog 16 at one end and to the dog-seat 10 at the other. In this first embodiment, as shown in FIG. 1, the dog 16 is provided with a harness 40 to which the strap 38 may be attached. Harness 40 remains attached to the dog 16 and enables the dog 16 to be easily released and fastened to the dog-seat 10, but may be unduly restricting to the released dog 16, and it may be time consuming to attach a harness 40 of this type to the dog 16.

The base 18 and head support 20 is typically fabricated from expanded polystyrene foam, and covered with a removable covering, made from cotton or nylon, for example. Such a construction, as widely used in ‘booster seats’ for children, is light and easily carried. The removable covering enables the dog-seat 10 to be easily cleaned, and is particularly useful for a dog 16 that is molting or is not fully housetrained, for example.

With reference now to FIG. 3, there is shown a second dog-seat 110 of the present invention, similar to the first embodiment, mutatis mutandis, except that the base 118 and head support 120 are fabricated as a single component. Although not having the same adjustability as the first dog-seat 10 described hereinabove and illustrated in FIGS. 1 and 2, it will be appreciated, that the simpler design will be cheaper to manufacture, and, by virtue of its simplicity, is more robust and less susceptible to damage. Dog-seat 110 may be injection molded out of one piece of plastic, such as expanded polystyrene for example. It is envisaged that a pet supplies retailer may carry a range of dog-seats 110 in different sizes for different sized dogs. Likewise a breeder or kennel club may manufacture a dog-seat 110 of this type with a particular species in mind. Dog-seat 110 restrains dog 16 by strap 38 and harness 40, and is supplied with a clasp type attaching means 24 for attaching the dog-seat 110 to the car seat 12 by seatbelt 36 in similar manner to the dog-seat 10 of the first embodiment, described hereinabove with reference to FIGS. 1 and 2.

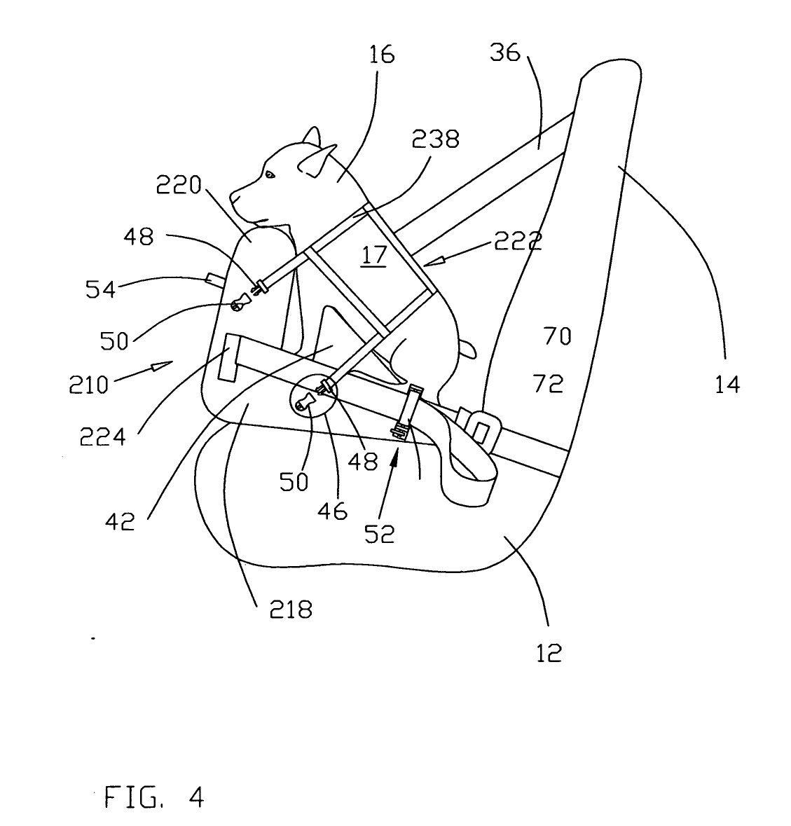

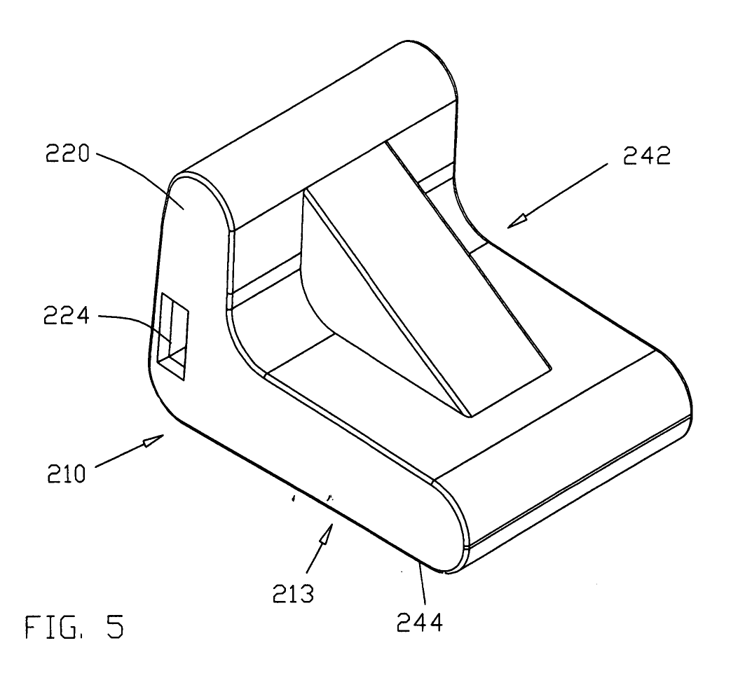

With reference now to FIG. 4, there is shown, in side elevation view, a third embodiment of a dog-seat 210 of the present invention, attached to a car seat 12 by the seatbelt 36, as before. Dog-seat 210 is similar to dog-seat 110 as illustrated in FIG. 3 mutatis mutandis, having base 218 and head support 220 fabricated as one piece, but, unlike the dog seats 10, 110 described hereinabove, dog-seat 210 of the third embodiment includes a body support section 42 that supports the body of the dog 16, enabling dog 16 to take his weight off his fore-legs, allowing the dog 16 to rest its front paws on long journeys, by providing an alternative means of supporting its weight, and perhaps to scrabble around. As shown in FIG. 5, the body support section 42 may be a simple triangular shaped component that connects the base 218 and head support 220, with cut away sections 244, providing room for the dogs legs on both sides thereof.

Referring back to FIG. 4, instead of a strap 38 attached to a harness 40 fixed to the dog 16, the restraining means 222 comprising a plurality of straps 238 that restrain the dog 16, evenly across its back 17, in a similar manner to that of the harness 22 of FIG. 3. The advantage of the dog-seat 210 of the third embodiment however, is that the straps 238 are equipped with quick release fixings 46 comprising interlocking male 48 and female 50 parts, that can be quickly separated, thereby unshackling the dog 16 completely. Consequently, this third embodiment is particularly attractive for frequent short commutes such as shopping and the like, where it is anticipated that the dog 16 will be released from the vehicle, and returned thereto several times.

Restrain 210 is designed to be semi-permanently strapped onto a back seat of a vehicle, and is provided with attaching means 24, that, as illustrated, includes a passageway 224 through which the seatbelt 36 may be threaded, for attaching the dog-seat 210 to the car seat 12. Also provided, is a tensioning means 52 that, as shown in FIG. 4 enables seatbelt 36 to be correctly tensioned to hold dog-seat 210 securely against back 14 of seat 12. As shown, the dog-seat 210 also includes a carrying handle 54 enabling the dog-seat to be carried conveniently, by one hand. Thus it is clear, that the dog-seat 210 can be easily removed or retrofitted to a car seat.

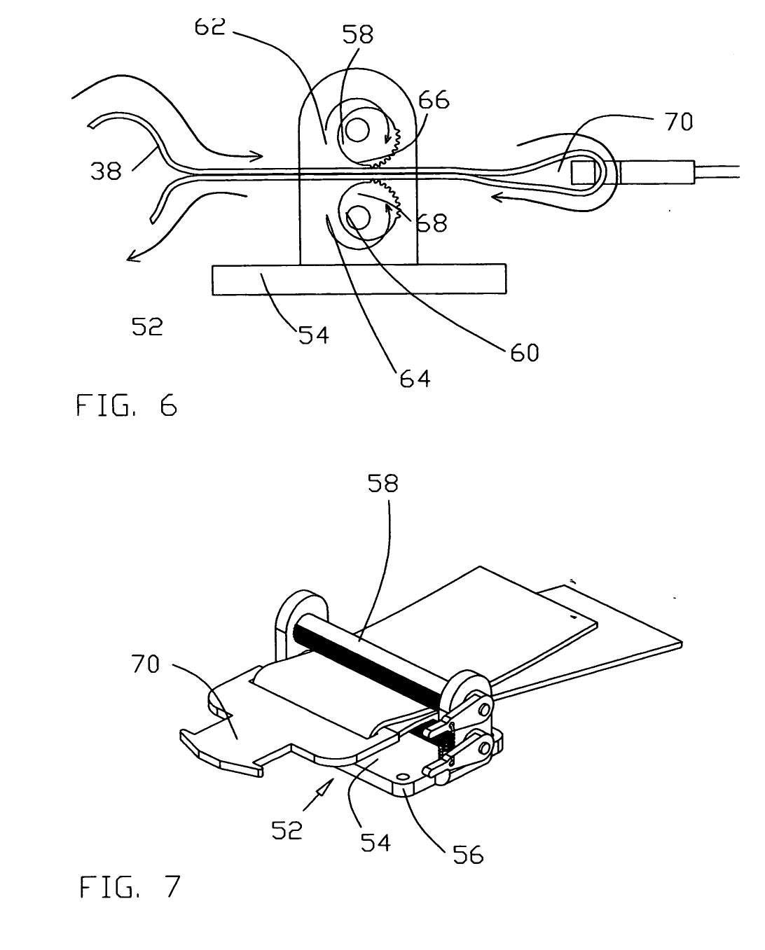

The tensioning means 52 of FIG. 4 is shown in more detail in FIGS. 6 and 7, in which it is shown that the tensioning means 52 consists of a plate 54 for fixing the tensioning means 52 to the base 218 of the dog-seat 210. The plate 54 may be provided with eyelets 56 that allow the tensioning means 52 to be attached to the base 218 with screws, rivets or the like. On base plate 54, there is provided a pair of sprung rollers 58, 60 mounted eccentrically on axes 62, 64. Sprung rollers 58, 60 are equipped with opposing toothed surfaces 66, 68. As known with car seatbelts, threaded onto the seatbelt 36 is a tongue 70 that fits into a corresponding socket 72. Referring back to FIG. 4, by virtue of the tensioning means 52, the seatbelt 36 may be adjusted so that the dog seat 210 is held tight up against back 14 of the car seat 12.

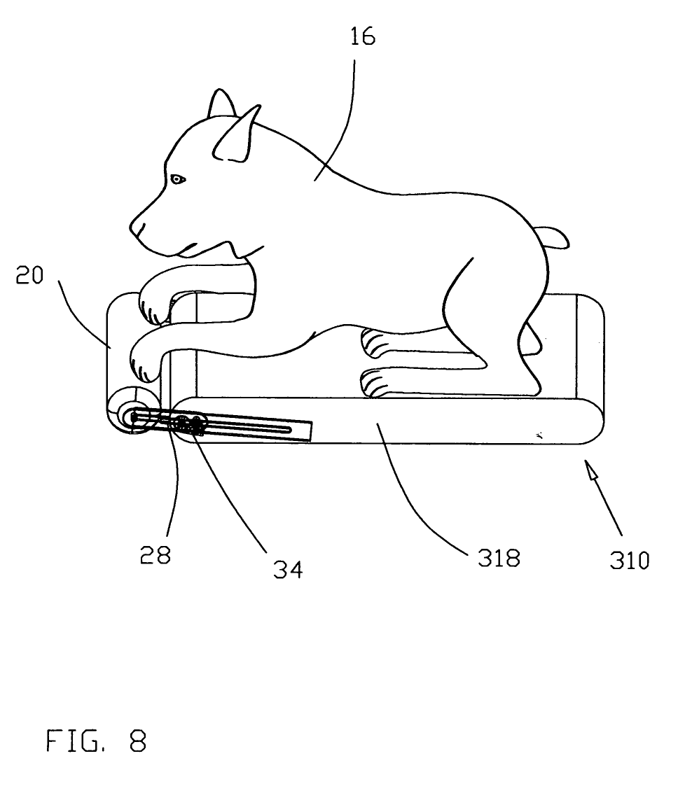

FIG. 8 is an isometric projection of a fourth type of dog-seat 310, that is similar in concept to the first embodiment, shown in FIG. 2, mutatis mutandis, except that the base 318 is completely flat, allowing the fore legs of a dog restrained thereon, greater freedom, but not including any type of ergonomic body support means.

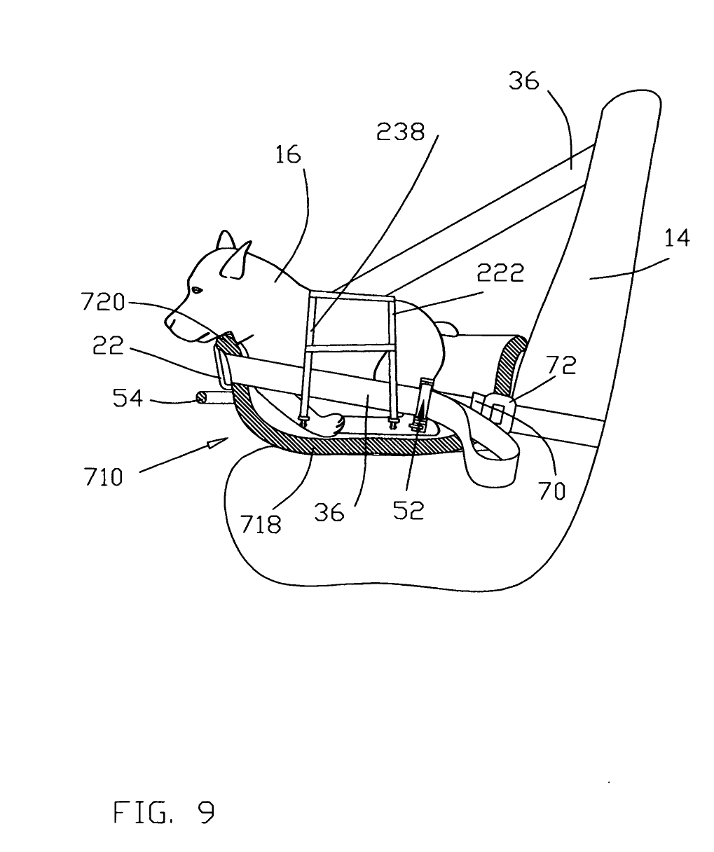

FIG. 9 shows yet another type of dog-seat 410, featuring a clasp 22, carrying handle 54, restraining means 222 comprising a plurality of straps 238 equipped with quick release fixings 48 and tensioning means 52, as described hereinabove with regards to the other embodiments. In this embodiment however, the base 418 of the dog-seat 410 is fashioned like a dog-basket, the rim 420 thereof, serving as a head support.

The various embodiments illustrated herein show how flexible the designs of dog-seats in accordance with the present invention are. Essentially the dog-seats all include a base that rests on the seat of a car, a head support that supports the head of the dog, a attaching means for attaching the dog-seat to the car using the seatbelt thereof and a restraining means. It will be appreciated that apart from the main function of restraining a dog 1, the dog-seats of the present invention also minimize the likelihood of loose hairs or mud from the dog's coat, getting onto the car seat. Although designed primarily for restraining dogs in automobiles, the dog-seat described herein, may be useful in other applications, and for restraining other animals.

Thus persons skilled in the art will appreciate that the present invention is not limited to what has been particularly shown and described hereinabove. Rather the scope of the present invention is defined by the appended claims and includes both combinations and subcombinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A dog-seat for restraining a dog within a vehicle; the dog-seat comprising a base, a head support, an attaching means and a restraining means: said base member configured to fit onto a seat of the vehicle; said attaching means configured to engage a seatbelt as provided with said seat, and said restraining means configured to restrain a dog upon said base without unduly constraining said dog.

2. The dog-seat of claim 1 wherein said dog upon said base is restrained in a manner that dog faces direction that a human passenger sitting on said seat would face.

3. The dog-seat of any of claims 1, said base and said head support being fabricated from a polymeric material.

4. The dog-seat of claim 3, said polymeric material being expanded polystyrene.

5. The dog-seat of claim 1, said base being covered with a fabric.

6. The dog-seat of claim 1, said head support being covered with a fabric.

7. The dog-seat of claim 1 said base and said head support being fabricated as a single unit.

8. The dog-seat of any of claim 1, said base and said head support being fabricated as separate units, coupled together by a coupling means.

9. The dog-seat of claim 8, said coupling means being pivotally connected to said base such that said head support can be rocked backwards and forwards with respect to said base.

10. The dog-seat of claim 8, said coupling means being telescopically extendible to comfortably accommodate dogs of different sizes.

11. The dog-seat of claim 10 further comprising a locking means for locking the coupling means at a desired extension.

12. The dog-seat of claim 1 further comprising a body support that allows the dog to rest its front paws on long journeys, by providing an alternative means of supporting its weight.

13. The dog-seat of claim 1, said restraining means comprising a harness attached to said dog and a strap for attaching said harness to said dog-seat.

14. The dog-seat of claim 1, said restraining means comprising a plurality of straps that restrains the dog, evenly across its back, said straps being attachable to said dog-seat by a quick release clasp.

15. The dog-seat of claim 1 further comprising a carrying handle.

16. The dog-seat of claim 1 further comprising a tensioning means for tensioning the seatbelt.

17. The dog-seat of claim 1, said tensioning means comprising a base plate on which is provided a pair of sprung rollers equipped with opposing toothed surfaces and mounted eccentrically on axes; said base plate for attaching said tensioning means to the dog-seat, and said tensioning means for allowing the seatbelt to be tensioned, so dog-seat rests on seat, tight up against back of seat.
